(19) United States
(12) Patent Application Publication
(10) Pub. No.: US 2012/0233347 A1
(43) Pub. Date: Sep. 13, 2012

(54) Transmedia User Experience Engines

(75) Inventors: Brian Elan Lee, Venice, CA (US); Michael Sean Stewart, Davis, CA (US); James Stewartson, Manhattan Beach, CA (US)

(73) Assignee: FOURTH WALL STUDIOS, INC., Culver City, CA (US)

(21) Appl. No.: 13/414,192

(22) Filed: Mar. 7, 2012

Related U.S. Application Data
(60) Provisional application No. 61/450,044, filed on Mar. 7, 2011.
(60) Provisional application No. 61/548,460, filed on Oct. 18, 2011.

(51) Int. Cl. G06F 15/16

(52) U.S. Cl. 709/231

(57) ABSTRACT

Transmedia experience engines are described having a transmedia server capable of delivering synchronized content streams of a story to multiple devices of a single user, or even to multiple users. The transmedia server can be coupled to a story server that stores at least one story comprising the content streams. The transmedia server can configure the user's media devices to present the story according to the synchronized streams.

This application claims the benefit of priority to U.S. provisional application having Ser. No. 61/450044 filed on Mar. 7, 2011, and U.S. provisional application having Ser. No. 61/548460 filed on Oct. 18, 2011. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is interactive digital technologies.

### Background

Consumers seek out ever more immersive media experiences. With the advent of mobile computing, opportunities exist for integrating real-world experiences with immersive narratives bridging across a full spectrum of device capabilities. Rather than a consumer passively watching a television show or listening to an audio stream, the consumer can directly and actively engage with a narrative or story according to their own preferences.

Interestingly, previous efforts of providing immersive narratives seek to maintain a distinction between the “real-world” and fictional worlds. For example, U.S. Pat. No. 7,810,021 to Paxson describes attempts at preserving a reader's immersive experience when reading literary works on electronic devices. Therefore, Paxson seeks to maintain discreet boundaries between the real-world and functional world. Unfortunately, narratives presented according to such approaches remain static, locked on a single device, or outside the influence of the consumer.

U.S. pat. publ. no. 2010/0029382 to Cao (publ. Feb. 2010) takes the concept of immersive entertainment slightly further. Cao discusses maintaining persistence of player-non-player interactions where the effects of an interaction persist over time. Such an approach allows for a more dynamic narrative. However, Cao's approach is still locked to a single device and fails to provide for real-world interactions with a consumer or other users.

Minor incremental progress is discussed in U.S. pat. publ. no. 2009/0313324 to Brooks et al. (publ. Dec. 2009). Brooks describes allowing users to view media content on one platform while reactive to stimuli through another platform. Although Brooks contemplates transmedia interactions, Brooks also fails to appreciate that a consumer or other user can interact with a story via real-world interactions.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Ideally, a consumer should be able to interact with a narrative or story as one would interact with the real-world, albeit through computing devices. For example, the consumer could call a character in a story via the character's cell phone, write a real email to a character, or otherwise actively interact with a story via real-world systems and devices. It has yet to be appreciated that a full transmedia user experience can be generated crossing boundaries of media types or media device while maintaining a synchronized event-triggered reality.

Thus, there is still a need for rich transmedia user experiences.

### SUMMARY OF THE INVENTION

The inventive subject matter provides apparatus, systems and methods in which one can provide a rich, synchronized transmedia user experience to many users via multiple user devices. One aspect of the inventive subject matter includes a transmedia experience engine capable of delivering synchronized content streams to multiple devices of a single user, or even to multiple users. In some embodiments, the transmedia experience engine comprises a transmedia server communicatively coupled with the user's devices. When the user requests an experience, herein referred to as a “story”, the transmedia server can obtain a story from a story server. Stories can comprise one or more story media streams that can be synchronously presented on multiple user media devices. The transmedia server can configure the user's media devices to present the story according to the synchronized streams.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of one embodiment of a transmedia experience engine.

FIG. 2 is a schematic of another embodiment of a transmedia experience engine.

FIG. 3 is a schematic of one embodiment of a user interface for a transmedia user experience.

FIGS. 4-6 are diagrams of exemplary uses of asset objects.

### DETAILED DESCRIPTION

It should be noted that while the following description is drawn to a computer/server-based transmedia experience system, various alternative configurations are also deemed suitable and may employ various computing devices including servers, interfaces, systems, databases, engines, agents, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on SMS, MMS, HTTP, HTTPS, AES, public-private key exchanges, web service APIs, known financial transaction protocols, or other electronic information exchanging methods. Data exchanges preferably are conducted over a network; cell networks, mesh networks, Internet, the LANs, WANs, VPNs, PANs, or other type of network.

One should appreciate that the disclosed techniques provide many advantageous technical effects including synchronizing multiple distinct media devices to present a rich media entertainment experience to one or more users.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The following discussion describes presenting a transmedia experience to a user as a story. A story is considered to comprise one or more data streams, herein referred to as “story streams”, carrying experience-related content and device commands. The device commands configure a user's media device to present the content of a story stream according to an overarching story. The story can include narrative (e.g., fiction, video, audio, etc.), interactive components (e.g., puzzles, games, etc.), promotions (e.g., advertisements, contests, etc.), or other types of user-engaging features. Users can interact with the content according to the programmed story. A story server or database can store one or more stories as story media streams, where each of the streams can target a specific media device or type of media device. A stream is considered to include a sequenced presentation of data, preferably according to a time-based schedule. One should also note the stream can be presented according to other triggering criteria based on user input. Triggering criteria can be based on biometrics, location, movement, or other acquired data.

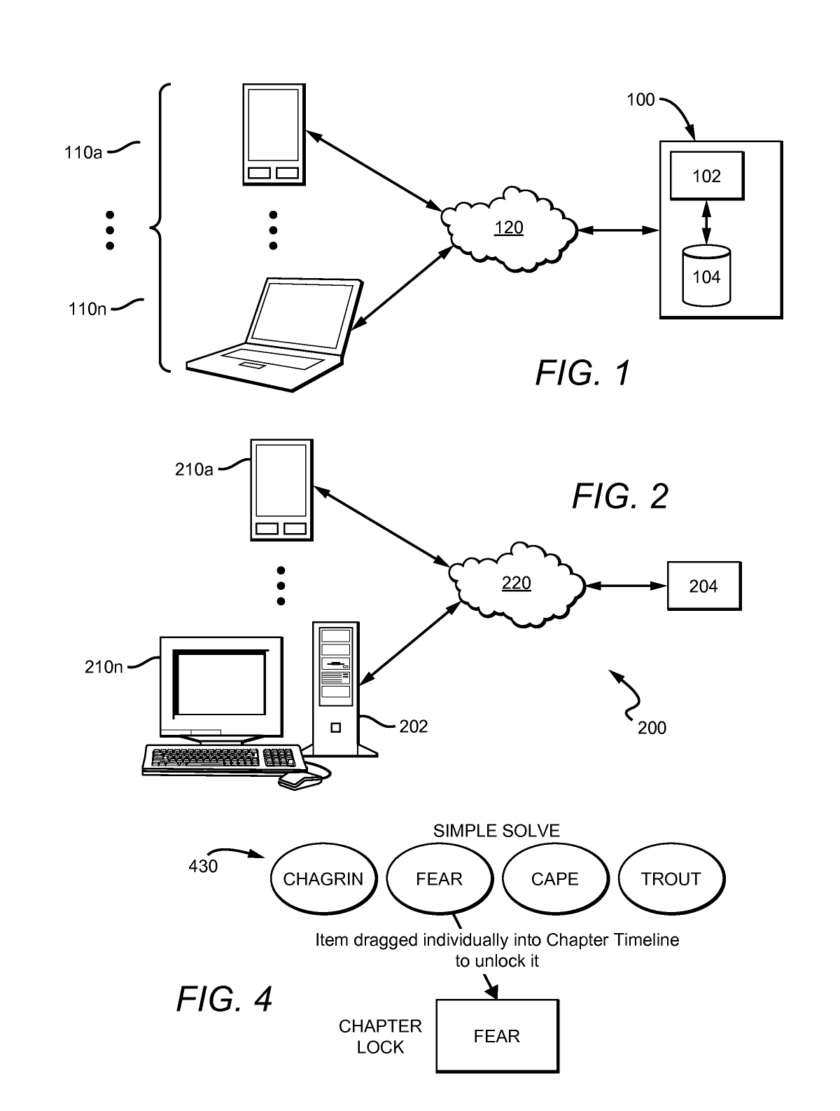

FIG. 1 illustrates a transmedia experience engine 100. Contemplated transmedia experience engines include one or more transmedia servers 102 operating as a multi-media delivery channel where the server(s) 102 deliver content related to a transmedia experience to one or more target media devices 110A-N. For example, a transmedia server 102 can be configured to deliver one or more story media streams to the target media devices 110A-N and configure the media devices 110A-N to present story elements of the story media streams in a synchronized manner according to a desired modality. Exemplary types of data that can be used to configure the media devices 110A-N to present different modal experiences include visual data (e.g., images, video, etc.), audible data, haptic or kinesthetic data, metadata, web-based data, or even augmented or virtual reality data. It is contemplated that each media device 110A-N can receive a story stream according to a modality selected for that media device. Thus, for example, the modality could automatically be selected based upon the capabilities of a specific media device, and different media devices can thereby receive story media streams having different modalities. For example, a laptop or other personal computer may receive audio and video data, while a mobile phone may receive only telephone calls and/or text or multimedia messages. In this manner, different pieces of a story can be delivered to different, sometimes unconnected, platforms.

Contemplated media devices capable of interacting with the story streams include mobile devices (e.g., laptop, netbook, tablet, and other portable computers, smart phones, MP3 players, personal digital assistants, vehicles, watches, etc.), desktop computers, televisions, game consoles or other platforms, electronic picture frames, appliances, kiosks, radios, sensor devices, or other types of devices. Media devices 110A-N preferably comprise different types of media devices, and it is preferred that the media device 110A-N are associated with a single user. In such embodiments, the user can thereby utilize multiple media devices 110A-N, each of which receives a story stream, to interact with a single story. It is further contemplated that the media devices 110A-N can be associated with multiple users where a first user may control a first media device 110A, and a second user may control a second user device 110B, and the first and second media devices 110A-B receive first and second story media streams, respectively.

Advantageously, it is preferred that one or more of the media devices 110A-N can include at least one sensor configured to collect ambient information about a user's environment. Such sensors could include, for example, GPS, cellular triangulation, or other location discovery systems, cameras, video recorders, accelerometers, magnetometers, speedometers, odometers, altitude detectors, thermometers, optical sensors, motion sensors, heart rate monitors, proximity sensors, microphones, and so forth.

The transmedia experience engine can further include a story server 104 coupled with the transmedia server 102, and configured to store at least one story comprising the two or more story media streams.

Although shown distal to the user media devices 110A-N, the various servers composing the transmedia experience engine 100 can be local or remote relative to the user's media devices 110A-N. For example, the story server 104 could be local to a user on a common network or even on one or more of the user's media devices 110A-N. Such an approach allows content or streams to be downloaded to a computing device local to the user or even to one or more of the user's media devices 110A-N. In this manner, should the user lose connectivity with a network, or the user's connectivity temporarily slow, the one or more devices 110A-N can still present its story stream seamlessly according to the stream's schedule or triggering criteria. It is also contemplated that the servers can be remote from one or more of the user's media devices 110A-N located across the Internet 120. Exemplary remote servers can include single purpose server farms, distal services, distributed computing platforms (e.g., cloud based services, etc.), or even augmented or mixed reality computing platforms.

Preferably, the transmedia server 102 provides at least two story media streams to at least two of the user media devices 110A-N in a synchronized manner. A single user can thereby experience both of the story streams substantially at the same time, possibly in real-time. For example, a user could be viewing a video stream on a computer (a first user media device) presenting a fictional security camera feed. The camera feed might represent content generated to further the story. At the same time, the user can place a real-world phone call using a second user media device, for example, to a character displayed on the screen, even when character is completely fictional or computer-generated. The user could then observe the character reacting to the phone call.

In another example, the user could be watching a scene and reach a point where a character's mobile phone is ringing. The user's mobile phone or other media device could also ring during this portion of the scene. It is contemplated that the scene may pause or loop until the user has answered his or her mobile phone, at which point the scene could continue. Thus, the story streams can remain synchronized and the user can listen to the phone call as the character would through the user's mobile phone, while also listening and viewing the character's response to the call using a separate media device.

In yet another example, the user could be interacting with a first story stream using a personal computer, and then use a second media device, such as a smart phone, to take a photo outside the user's window and send the photo to a character in the story. It is especially preferred that the second device could utilize software loaded on the device to overlay fictional characters in the photo (e.g., a patrol car or a lookout van parked outside). In this manner, the photo can be augmented to further immerse the user in the story. A more detailed discussion of the use of augmented reality in game play can be found in U.S. provisional application having Ser. No. 61/450052 filed on Mar. 7, 2011, which is incorporated by reference in its entirety.

It is further contemplated that each story can include event triggering criteria that when met cause a change within the story. Such changes can include, for example, advancing the story, unlocking content, changing content, and so forth. For example, the story server 104 could trigger one or more events based on real-world user actions satisfying the event triggering criteria. It is also contemplated that the story server or other server, or one or more of the user's media device, could advance one or more of the story streams as a function of the event triggering criteria. Contemplated event triggering criteria can include, for example, reaching a predetermined video or audio key frame, pressing a button or other interface, accessing a link, reading an email, responding to an email, responding to a text, multimedia or instant message, visiting a website, closing or opening a window, answering or terminating a phone call, scrolling within a user interface, parsing a text message, printing a document, receiving or sending a fax message, and so forth.

Contemplated real-world actions include, for example, calling a phone number, sending an email or text message, going to a specific location, printing directions, a coupon, or other information, purchasing an item, collecting a virtual or real-world item, capturing sensor data including taking a picture, and accessing a website.

One should appreciate that presenting synchronized streams does not require that the streams be always presented simultaneously. Rather, presenting synchronized streams is contemplated to include presenting data from two or more story streams at proper times relative to one another. In some scenarios the story streams can be presented according to a programmed schedule where the schedule can include absolute times or relative times. While in other scenarios the sequence of presented events in the story streams can be triggered by the user's interactions with any of the story streams as per the example described above. In such scenarios, the story server can adjust the story accordingly when the user's interactions satisfy requirements or optional conditions of event triggering criteria. Thus, a story stream can comprise an interactive stream capable of being influenced by the user's real-world interactions. For example, a user may receive a first story stream to a first media device, and may receive a second story stream to a second media device on a periodic basis at predefined points in the story. Thus, while the user does not continuously receive both streams simultaneously, the streams are synchronized with respect to the story and each other. Furthermore, it is contemplated that a single story could be presented to multiple, distinct users where each of the user's real-world interactions can influence other user's experiences by triggering events causing playback of a sequence of story elements in one or more story streams.

An astute reader will appreciate that greater levels of immersion are capable of being achieved via the disclosed techniques. Because users can interact, quite intimately, with a story through their real-world actions, there exists a possibility that the user could become overly immersed within the story. To limit a user's level of immersion within a story, the inventive subject matter is also considered to include providing one or more immersion-level control commands to one or more of the user's media devices to remind the user of the story's fictional nature. In some embodiments, an immersion-level control command can be auto-generated based on when a user's interactions satisfy predefined immersion criteria. The immersion criteria can be based on a priori set of preferences, parental controls, or even based on a behavior signature. In the example shown in FIG. 2, to some extent the “Help” button or other prominent features aid to remind the user of the story's fictional nature.

The immersion-level control command can be sent to the transmedia server, or simply cause one of the user's media devices to take an action. In some contemplated embodiments, the immersion-level control command can comprise an auto-generated disruption event to the synchronized streams. For example, when the user's interactions satisfy the predefined immersion criteria, a pop-up notice can be sent to one or more of the user's media devices and a control command can be sent to the transmedia server to pause the synchronized streams.

An immersion level can be quantified in numerous manners depending upon the specific application. For example, an immersion level could be based upon the length of time of continuous game play by a user, which could be measured from a start time or time when game was last paused more than five minutes, or some other predefined time period. After a user has played continuously for more than a predefined time period, the transmedia server 102 or other server could take one or more actions including, for example, pausing the story, stopping the story, recommending a break to the user such as through a pop up or other notification, disabling game play, and so forth. It is also contemplated that the transmedia server 102 or other server could gradually decrease a user's level of immersion if a user meets one or more predefined conditions, to thereby reduce the likelihood of startling the user. A level of immersion could also be based on prior research to determine an average amount of time at which users began having one or more undesired effects from the continuous game play. The level of immersion could also be based upon a heart rate of the user, eye contact of the user with the game, or other scales.

The nature of a story can range from the most simple of interactions through highly complex, epic quests. As discussed above, the quests can be web-based or utilize an application or other interface. As illustrated via the time-shifting commands, the user can control aspects of a story's progress. In some embodiments, the user can also select a duration of a story by setting one or more preferences. This advantageously allows a user to limit his or her interaction with a story to a set time period to ensure the user does not become overly immersed in a story and potentially forget about real-life responsibilities, for example.

Alternatively, the duration or even a complexity level can be adjusted based on an observed user behavior. For example, the engine 100 could monitor the length of time it takes a user to solve one or more problems/puzzles/etc. to determine an appropriate complexity level. In some embodiments a single story might have many levels of complexity where the user can dive as deep into the story as desired based on a selected complexity level. For example, a casual user might select a low complexity level or a short duration, which causes the story server to adjust the story to meet the complexity level or duration requirements. It is further contemplated that the story streams of a story can have the same or different complexity levels. This thereby allows a user to select a great complexity level for the story stream transmitted to a laptop computer, for example, than the story stream transmitted to the user's mobile media device.

One aspect of the inventive subject matter is considered to include adjusting a scope of a story based user interactions. Such an approach can be achieved due to the fractal nature of a possible story where the user can figuratively peel away the layers of the story as the story progresses. Consider an example, where a story involves characters having cell phones. A first user might simply watch the characters or graphically interact with the characters at a first layer. A second user wishing to have a more substantial interaction can also interact with the characters at the first layer as well as call the character's cell phones to uncover a second layer of the story. In view that a story can comprise a fractal structure, layers can be added to the story even after the story has been published thereby increasing the depth of the detail available in the story.

It is further contemplated that engine 100 could include a delivery verification engine configured to verify delivery of content such as a story stream to a user media device. For example, the delivery verification engine could detect whether or not a user answers a phone call to the user's mobile telephone. If the call is not answered, the delivery verification engine can alert at least one of the transmedia server 102 and the story server 104, such that one or more of the story streams can be modified, as necessary, to account for the error. For example, a story stream could be modified to overlay the conversation on a different device so that the user can hear the phone call as intended.

FIG. 2 illustrates another embodiment of a transmedia experience engine 200, in which the transmedia server 202 is local to at least one of the user media devices 210A. With respect to the remaining numerals in FIG. 2, the same considerations for like components with like numerals of FIG. 1 apply.

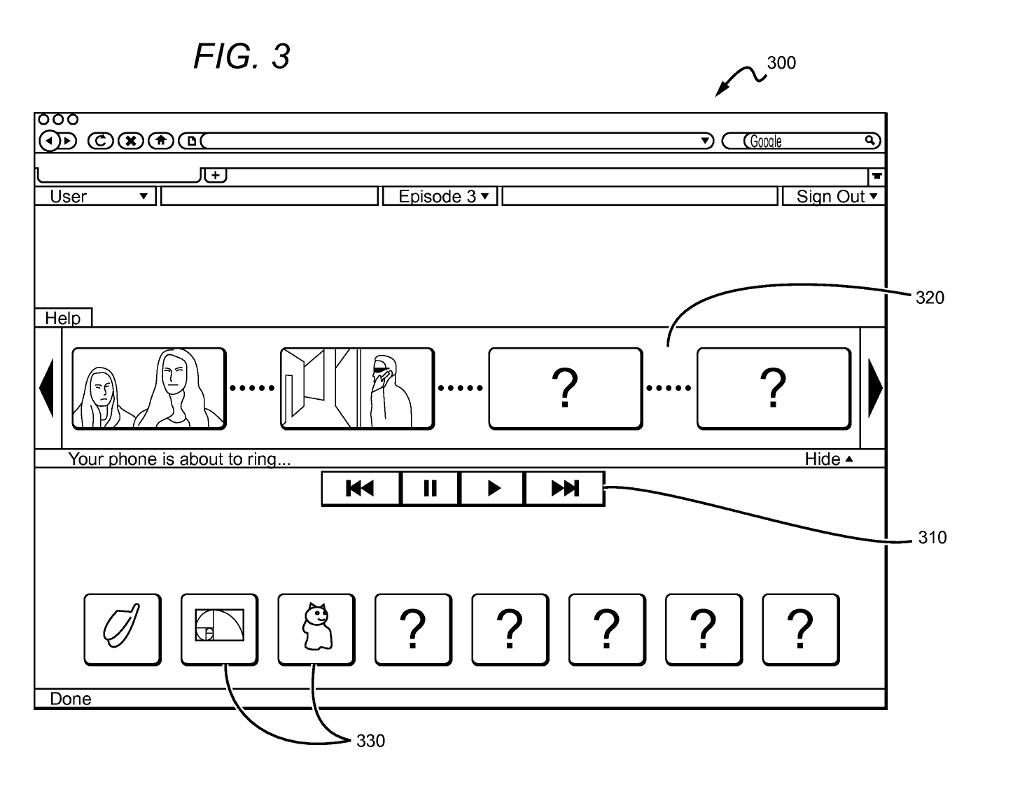

A user can interact with a story through a user interface 300, such as that shown in FIG. 3. In some contemplated embodiments, the user interface 300 can be configured to allow the user to cause one or more story control commands to be sent to a story server, such as that described above, where the story control commands control aspects of the synchronized story streams. Exemplary commands can include, for example, time shifting commands related to the synchronized story streams (e.g., fast forward, rewind, pause, play, skip, etc.), unlock content commands, event trigger commands, or other types of commands.

When a user selects a control command icon 310 such as a time shifting command, for example, the command can be sent to a transmedia server such as that described above controlling the synchronized streams. Thus, for example, if a user desires to fast forward or skip a portion of the story, as permitted, the user can either select the fast-forward or skip object to transmit the desired command to a transmedia server. After receiving the control command, the transmedia server can then control each of the story streams such that the story streams remain synchronized after time shifting. For example, if a user desires to time shift a portion of the story, each of the story streams must also be time-shifted as necessary such that the story streams maintain their synchronization. Otherwise, a story stream could become out of sync with another story stream of the story.

Of course, the ability of the user to utilize one or more control commands will depend on the story. In some portions of a story, it is contemplated that one or more control commands could be disabled, at least temporarily.

Although FIG. 3 illustrates the user interface 300 as a web page, one should appreciate that the user interface could comprise other types of interfaces beyond a web page. In some embodiments, for example, the user interface can include an application program interface (API), through which commands or data can be exchanged interact with the transmedia experience engine's servers. In addition, the user interface 300 can also include a story agent application deployed on one or more of the user's media devices where the devices become the user interface. For example, a user could download a story agent application to their smart phone allowing the smart phone to acquire user-related input affecting the story. User input can include active input or passive input. Active input can include interaction with the user interface via one or more input interfaces (e.g., keyboard, mouse, touch screen, accelerometer, magnetometer, camera, etc.). Passive input can include, for example, ambient data acquired via one or more sensors (e.g., accelerometer, magnetometer, camera, GPS, etc.) regardless of the user interface. User input, active or passive, can be used to trigger one or more events within a story.

User interface 300 can include several additional features of note. First, the user interface 300 comprises a web-based interface configured to present a transmedia experience combining a video with a user's cell phone. As the user interacts with the unfolding story, the interface can display the user's progress via timeline 320. In the example shown, the user has unlocked two chapters of a story. Second, the interface 300 illustrates story control command icons 310 available to the user. In the example shown, the story control commands include time shifting commands, such as rewind, pause, play, and fast forward. Third, the user is also presented with one or more asset objects 330 (i.e., inventory objects) collected via the user's interaction with the story. Asset objects could be collected as part of a web-based quest, for example. As the user browses the web according to the quest, the user collects the asset objects indicating fulfillment of their quests. In addition, asset objects 330 can be collected passively or actively. For example, some asset objects can be collected passively by the user as the user progresses through a story (e.g., a user may receive an asset object representing an argument between two characters after the user observes the characters' argument). Asset objects can also be actively collected by the user in various manners, such as quests, combining existing asset objects, completing objectives, exploring a virtual or real-world environment, and so forth.

As shown in FIG. 3, asset objects 330 can be represented as graphical icons, but could also be represented as text in a list, colors, images, videos, or in any other format. However, asset objects can include a full spectrum of objects including achievements, badges, audio objects, video objects, currency, points (e.g., award points, experience points, etc), addresses (e.g., unlocked phone numbers, URLs, email addresses, etc.), bookmarks, and images. Additional asset objects of interest can include promotions or advertisements (e.g., coupons, contests, etc.) allowing the user to discover new commercial opportunities. Asset objects could further include more abstract ideas such as emotions and so forth (e.g., sunshine, music, anger, envy, memory, etc.). Asset objects 330 can be tracked via an asset management server, which could include the story server or the transmedia server, as the user progresses through the story. The asset objects could be purely virtual objects, real-world objects, or a combination of both.

Asset objects 330 can advantageously be used by the user for various purposes depending upon the story. For example, in their simplest form, asset objects could be used to unlock other chapters of a story, such as that shown in FIG. 4. The asset objects 330 could also be used to advance or unlock content in the story or another story.

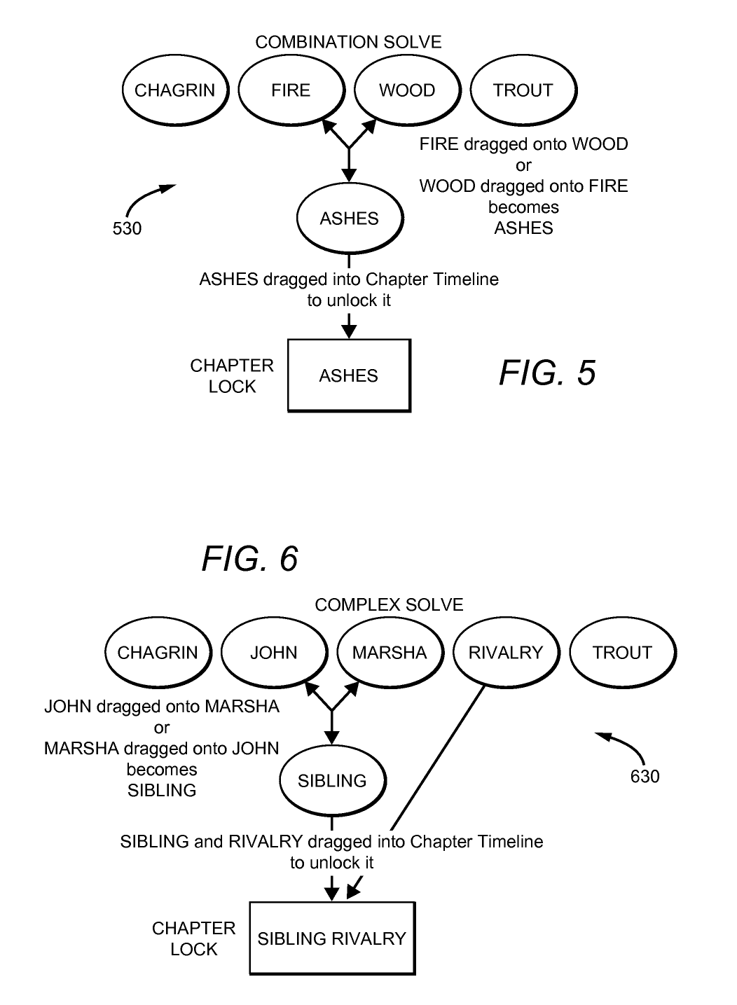

Of particular interest, asset objects can include active objects capable of triggering actions. An especially interesting use of active asset objects includes allowing the user to discover combinations of asset objects that can be combined to form new objects, which may then be used to unlock additional objects, skills, or other features or content. For example, combining a string of numbered icons together (e.g., 1, 1, 2, 3, 5, 8, etc.) might create a Fibonacci object, which can then operate as a key object to unlock additional features or content, possibly a new chapter. Other exemplary combinations of asset objects are shown in FIGS. 5-6.

In FIG. 4, a simple solution is shown in which a user uses the “fear” asset object 430 to unlock a chapter of the story.

FIG. 5 illustrates an exemplary embodiment in which a user must combine two or more asset objects 530 (e.g., “fire” and “wood”) to create a new asset object “ashes”. The “ashes” object can then be used to unlock a chapter of the story. FIG. 6 illustrate another embodiment in which a user must combine two asset objects 630 to form a new asset object, and then utilize the newly formed object (e.g., “sibling”) and a previously-existing object (e.g., “rivalry”) to unlock a chapter of the story.

A platform capable of supporting the disclosed system in under development by Fourth Wall Studios^{SM}, Inc., called RIDES^{SM}, currently available at http://fourthwallstudios.com/platform.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A transmedia experience engine comprising:
a transmedia server coupled with a plurality of user media devices associated with a single user;
a story server coupled with the transmedia server and storing at least one story comprising story media streams; and
wherein the transmedia server configures at least two of the user media devices to present at least two story media streams as synchronized streams on the user media devices.

2. The engine of claim 1, wherein at least one of the story media streams comprises an interactive stream.

3. The engine of claim 1, wherein the at least two story media streams comprise different modalities.

4. The engine of claim 3, wherein the modalities include at least one of the following data types:
visual data, audible data, haptic data, metadata, web-based data, and augmented reality data.

5. The engine of claim 1, wherein the plurality of media devices are associated with multiple users.

6. The engine of claim 1, wherein the at least two user media devices are selected from the group comprising a phone, a computer, a television, a radio, an appliance, an electronic picture frame, a vehicle, a game platform, and a sensor.

7. The engine of claim 1, further comprising a user interface coupled with the story server and configured to allow the user to cause time-shifting commands to be sent the transmedia server controlling the synchronized streams.

8. The engine of claim 7, wherein the time-shifting commands controlling the story media streams include at least one of the following commands: fast-forwarding the synchronized streams, rewinding the synchronized streams, playing the synchronized streams, pausing the synchronized streams, unlocking the synchronized streams, triggering an event, and skipping the synchronized streams.

9. The engine of claim 7, wherein the user interface comprises a smart phone comprising at least one sensor.

10. The engine of claim 7, wherein the user interface comprise a web-based interface configured to present a user's progress along the at least one story.

11. The engine of claim 1, wherein the at least one story comprises event trigger criteria causing a change within the at least one story.

12. The engine of claim 11, wherein the story server triggers an event based on real-world user actions satisfying the event trigger criteria.

13. The engine of claim 12, wherein the real-world user actions include at least one of the following: calling a phone number, sending an email, going to a specific location, and capturing sensor data.

14. The engine of claim 1, wherein the at least one story comprises a web-based quest.

15. The engine of claim 1, further comprising an asset management server configured to track user collected asset objects according to a user's progress along the at least one story.

16. The engine of claim 15, wherein the asset objects comprise a key object unlocked by combinations of asset objects and configured to unlock additional content of the at least one story.

17. The engine of claim 15, wherein asset objects comprise at least one of the following: an icon, an image, an audio clip, a promotion, a virtual object, a badge, a currency, a point, and an address.

18. The engine of claim 1, wherein the story media streams comprise an immersion-level control command.

19. The engine of claim 18, wherein the immersion-level control command comprises an auto generated disruption event to the synchronized streams.

20. The engine of claim 1, wherein the at least one story comprises a user controlled duration.

21. The engine of claim 1, wherein the at least one story comprises variable complexity levels.

22. The engine of claim 21, wherein the synchronized streams present the story according to a selected complexity level.

23. The engine of claim 1, wherein at least one of the story and transmedia servers, at least in part, are on a local network with the at least one of the user media devices.

24. The engine of claim 1, wherein at least one of the story and transmedia servers, at least in part, comprise a distal service.
